(19) United States
(12) Patent Application Publication
(10) Pub. No.: US 2002/0066092 A1
(43) Pub. Date: May 30, 2002

(54) Information apparatus which can download and update its system program from a network

(76) Inventor: Shu-Ming Liu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/682,571

(22) Filed: Sep. 21, 2001

(30) Foreign Application Priority Data
Sep. 22, 2000 (TW) 08911600

(51) Int. Cl. G06F 9/445

(52) U.S. Cl. 717/168; 717/173

(57) ABSTRACT

An information apparatus (IA) has a first storage device for storing a systems program. The systems program is used to control operations of the IA. The IA has a processor for executing the systems program, a communications device for handling communications between the information apparatus and a network, and a read-only storage device for storing a rescue program. When the processor executes the rescue program stored in the read-only storage device, the information apparatus utilizes the communications device to download a systems update program from the network to update the systems program of the information apparatus.

### BACKGROUND OF INVENTION

1. Field of Invention

The present invention relates to an information apparatus (IA) and, in particular, to an IA that can update its systems program from a network.

2. Description of the Prior Art

The usual information apparatus (IA) can provide simple online functions that allow the user to get onto a network in a simple and cheap way. Most of the IAs store their systems programs in erasable programmable read-only memory (EPROM), or flash memory. However, due to the ever-present threat of computer viruses on the network, the systems programs of such IAs are often in danger of being infested by of computer viruses. In particular, the speed with which computer viruses spread through the network is amazingly fast. In addition, new and malignant computer viruses are constantly coming out, making it hard to prevent, or cure, infections. To avoid, or recover from, damage caused by computer viruses, or from human error, the systems programs of the IAs are kept backed up on a storage device, such as a floppy disk drive or a CD-DOM. When the user wants to update the systems program, he or she must put the floppy disk or optical disk with the backup systems program into the floppy disk drive or CD-ROM and start the relevant procedures to restore the systems program.

However, the conventional method has a drawback. Since the backup systems program is stored on a floppy disk or an optical disk, the user may not be able to promptly and readily find it. Even if it is found, the backup systems program may be of an older version. Furthermore, some IAs are not equipped with appropriate storage devices to read the backup systems programs. Under these conditions, updating the systems program will prove troublesome.

### SUMMARY OF INVENTION

It is therefore an objective of the present invention to provide an IA that can update its systems program from a network.

Briefly summarized, an information apparatus (IA) of the present invention is capable of connecting to a network. The IA has a first storage device for storing a systems program. The systems program is used to control operations of the IA. The IA has a processor for executing the systems program, a communications device for handling communications between the information apparatus and the network, and a read-only storage device for storing a rescue program. When the processor executes the rescue program stored in the read-only storage device, the information apparatus utilizes the communications device to download a systems update program from the network to update the systems program of the information apparatus.

It is an advantage that the present invention IA utilizes the online functionality of the IA to download a systems update program from a network to replace its original systems program. In this manner, the IA can automatically restore or update its systems program from the network.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a schematic view of an IA of the invention.

FIG. 2 is a functional block diagram of the IA of FIG. 1.

### DETAILED DESCRIPTION

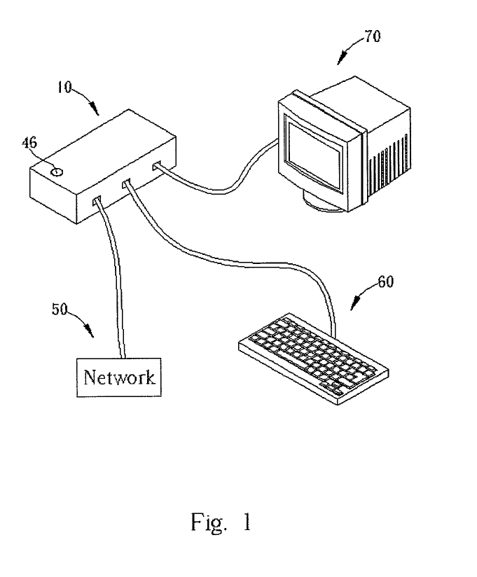

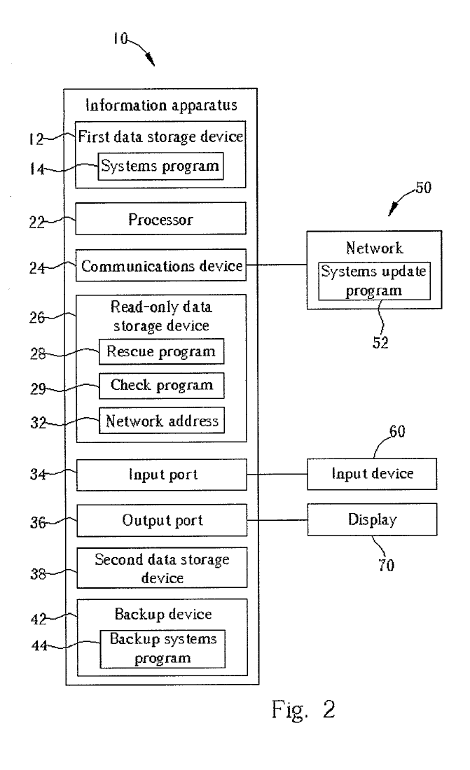

With reference to both FIGS. 1 and 2, the information apparatus (IA) 10 of the present invention provides online functionality that allows homepage browsing, the transmitting and receiving of e-mail messages, and connecting to a bulletin board system (BBS) to read posted articles.

The IA 10 contains a first data storage device 12 to store a systems program 14, a processor 22 to execute the systems program 14, a communications device 24 to control the connectivity of the IA 10 to a network 50, and a read-only data storage device 2 to store a rescue program 28. The systems program 14 is an operating systems program to control the operations of the IA 10. The processor 22 can execute the rescue program 28 in the read-only data storage device 26 and download a systems update program 52 from the network 50 through the communications device 24, replacing the systems program 14 stored in the first data storage device 12.

The IA 10 has a button device 46, and the read-only data storage device 26 stores at least one network address 32. When a user notes abnormal operation of the IA 10, or wants to update the systems program 14, he or she can trigger the button device 46 to generate an update signal that is sent to the processor 22. When the processor 22 receives the update signal, the IA 10 will download the systems update program 52 from the network address 32. The user can determine when to update the systems program 14. When the user wants to update the systems program 14, he or she only needs to trigger the button device 46 and the processor 22 will automatically update the systems program 14.

The read-only data storage device 26 further includes a check program 29 to check whether the systems program 14 needs to be updated. The check program 29 will inform the processor 22 to process the rescue program 28 to download a systems update program 52. Through comparison between the systems program 14 and the systems update program 52, the check program 29 determines whether the systems program 14 needs to be updated. When the systems program 14 and the systems update program 52 are different, the check program 29 informs the processor 22 to execute the rescue program 28 to download the systems update program 52 to update the systems program 14. Moreover, the check program 29 also compares the systems program versions. When the version of the systems update program 52 is newer than that of the systems program 14, the check program 29 will inform the processor 22 to download the systems update program 52 to update the systems program 14. Therefore, the IA 10 can have the most up-to-date version of systems program 14.

The communications device 24 can be a modem, a cable modem, or a network card that connects to the network 50 and that uses transmission control protocol/Internet protocol (TCP/IP) to transmit and receive data. The IA 10 further contains a second data storage device 38 which can be electronic memory or a disk drive device to store data downloaded from the network 50. The data received by the communications device 24, such as homepage data, E-mail messages, etc, can be stored in the second data storage device 38. In the process of downloading the systems update program 52 from the network 50 to the communications device 24, the systems update program 51 is first stored in the second data storage device 38. Only until the systems update program 52 is completely downloaded does the processor 22 replace the systems program 14 by the systems update program 52. For communications devices with a slower transmission speed, or when the network is heavily loaded, it is possible to have the transmission interrupted during a long transmission time. Therefore, the rescue program 28 is designed to have download continuation functionality. When the processor 22 is interrupted during the execution of the rescue program 22, or connection to the network is lost, only the portion of the systems update program 52 that was not downloaded last time needs to be transmitted the next time when the rescue program 22 runs.

The read-only data storage device 26 is read only memory (ROM) to store the rescue program 28, the check program 29 and the homepage addresses 32 in the read-only way so as to ensure the correctness of the data. The first data storage device 12 consists of flash memory or erasable programmable read-only memory (EPROM) so that the processor 22 can install the systems update program 52 therein after the system program 14 is removed.

The IA 10 also contains an input port 34 electrically connected to an input device 60 for the user to input data, and an output port 36 electrically connected to a display 70 for displaying the operating conditions of the IA 10. The process of updating the systems program causes the whole system to be updated, and may influence all the data and settings stored in the IA 10 by the user. To prevent the user from accidentally activating the button device 46, the IA 10 will first request the user to confirm the downloading action, or request a password through the input device 60 before the systems update program 52 is downloaded. Furthermore, the IA 10 also allows the user to determine from which homepage address the processor 22 should download the systems update program 52. Before the processor 22 downloads the systems update program 52 from the network 50, the processor 22 will ask the user to choose or enter a homepage address through the input device 60 so that the IA 10 downloads the systems update program 52 from the given address. This action of choosing or entering a homepage address is displayed on the display 70 in an on screen display (OSD) manner.

Aside from downloading the systems update program 52 from the network 50, the IA 10 can have an additional backup device 42 to store a backup systems program 44. The processor 22 will read in the backup systems program 44 from the backup device 42 to replace the systems program 14 originally stored in the first data storage device 12. If it is impossible to read in the backup systems program 44 from the backup device 42, the processor 22 will then download the systems update program 52 from the network 50 through the communications device 24.

In addition, the systems program 14 need not only be an operating system program, but may also include a basic input/output system (BIOS). That is, the present invention may not only update the above-mentioned operating system program, but may also update the BIOS in the IA. Of course, the invention can update both the operating system program and the BIOS at the same time. As long as one uses the rescue program and the network to update the systems programs of the IA, the method would be within the scope of the present invention.

In comparison with conventional IAs, the disclosed IA 10 uses its online functionality to automatically or manually cause downloading of the systems update program 52 from the network 50 so as to replace the original systems program 14 therein. The user can readily update or restore the systems program 14 of the IA 10, thus greatly reducing a lot of unnecessary maintenance burdens.

Certain variations would be apparent to those skilled in the art, which variations are considered within the spirit and scope of the claimed invention.

What is claimed is:

1. An information apparatus (IA) connected to a network, the information apparatus comprising:
a first storage device for storing a systems program, the systems program being used to control operations of the information apparatus;
a processor for executing the systems program;
a communications device for handling communications between the information apparatus and the network; and
a read-only storage device for storing a rescue program;
wherein when the processor executes the rescue program stored in the read-only storage device, the information apparatus utilizes the communications device to download a systems update program from the network to update the systems program of the information apparatus.

2. The information apparatus of claim 1 further comprising at least one button for generating and transmitting an update signal to the processor, wherein pressing of the button causes the processor to execute the rescue program, resulting in the information apparatus downloading the systems update program from the network.

3. The information apparatus of claim 1 wherein the read-only storage device further stores a check program for checking whether the systems program requires updating, and when the check program confirms a need for updating the systems program, the check program informs the processor to process the rescue program and download the systems update program from the network.

4. The information apparatus of claim 3 wherein the check program compares the systems program with the systems update program to determine whether the systems program needs updating, and when the systems program differs from the systems update program, the check program informs the processor to process the rescue program and download the systems update program from the network.

5. The information apparatus of claim 1 wherein the read-only storage device is a read only memory (ROM).

6. The information apparatus of claim 1 wherein the first storage device is a flash memory.

7. The information apparatus of claim 1 wherein the first storage device is an erasable programmable read-only memory (EPROM).

8. The information apparatus of claim 1 wherein the systems program is an operating system (OS) program.

9. The information apparatus of claim 1 wherein the systems program is a basic input/output system (BIOS).

10. The information apparatus of claim 1 wherein the systems program comprises both an operating system and a basic input/output system.

11. The information apparatus of claim 1 wherein the read-only storage device stores at least one network address, with the information apparatus downloading the systems update program from the network address.

12. The information apparatus of claim 1 further comprising an input port and an output port, wherein the input port is electrically connected to an input device, and the output port is electrically connected to a display, a user capable of inputting commands to the information apparatus via the input device.

13. The information apparatus of claim 12 wherein prior to the downloading of the systems update program, the information apparatus requests the user to confirm the downloading action via the input device.

14. The information apparatus of claim 12 wherein prior to the downloading of the systems update program, the information apparatus requests the user to input a password via the input device.

15. The information apparatus of claim 12 wherein the processor requests the user to specify a network address via the input device, followed by the information apparatus downloading the systems update program from the network address specified by the user.

16. The information apparatus of claim 15 wherein the display has an OSD (on screen display) function so that when the user inputs or chooses the network address, the results of the user's operations are shown on the display.

17. The information apparatus of claim 1 wherein the communications device is a modem, a cable modem, or a network card.

18. The information apparatus of claim 1 wherein the communications device receives and transmits data according to the transmission control protocol/internet protocol (TCP/IP).

19. The information apparatus of claim 1 further comprising a second storage device for storing data downloaded from the network.

20. The information apparatus of claim 19 wherein the second storage device is a electronic memory or a disk.

21. The information apparatus of claim 1 further comprising a backup device for storing a systems backup program, whereby when the processor updates the systems program, the processor reads the systems backup program from the backup device and then updates the systems program with the systems backup program, whereby if the processor cannot read the systems backup program, the processor downloads the systems update program from the network.

22. The information apparatus of claim 1 wherein when the downloading process of the information apparatus is interrupted, the next time the information apparatus downloads the systems update program, only the portion of the systems update program that has not been downloaded is downloaded.

23. The information apparatus of claim 1 wherein the information apparatus is used to browse homepages.

24. The information apparatus of claim 1 wherein the information apparatus is used to receive, send, and read e-mail.

25. The information apparatus of claim 1 wherein the information apparatus is used to connect to a bulletin board system (BBS), and read bulletins posted on the bulletin board system.
